(19) United States
(12) Patent Application Publication
(10) Pub. No.: US 2007/0165632 A1
(43) Pub. Date: Jul. 19, 2007

(54) Method of providing a rendezvous point

(75) Inventor: John Michael Zwiebel, Santa Cruz, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Cisco Technology, Inc.

(21) Appl. No.: 11/331,707

(22) Filed: Jan. 13, 2006

(51) Int. Cl. H04L 12/56

(52) U.S. Cl. 370/390

(57) ABSTRACT

A method and network device are described for providing a rendezvous point (RP) functionality in protocol independent multicast (PIM) communications in a communications network. The method may comprise defining an RP sub-network identified by an RP address, the RP sub-network comprising a plurality of network devices and designating one of the plurality of network devices to perform RP functionality based on a designation rule. A rendezvous point (RP) facility for a sparse mode protocol independent multicast (PIM) system on a data communications network. The RP facility comprises a sub-network which includes a plurality of routers having respective individual IP addresses, one of the routers having an active RP address and thus being a designated router (DR) for performing RP processing. A selection component may automatically select, in response to a failure event associated with the DR, another router as new DR.

### TECHNICAL FIELD

This application relates generally to multicasting over data communication networks. In an example embodiment, a method and system is described for providing a rendezvous point (RP) facility in sparse mode protocol independent multicast (PIM) communications over a communication network.

### BACKGROUND

A multicast network which uses sparse mode PIM requires a RP to build and to manage a shared tree, and to communicate with host computer systems needing to send or receive multicast data packets. The RP is assigned to one or more routers. RP redundancy is desirable for continuing functioning of the multicast network when the router serving as RP fails or otherwise becomes inoperative.

Current redundancy solutions include assigning the same IP (Internet Protocol) address associated with the RP (further referred to as the RP address) to a plurality of routers, forming a so-called PIM Anycast RP. This arrangement has some advantages, but may require use of MSDP (Multi Source Discovery Protocol) to keep the routing tables of the routers synchronised. Another solution comprises changing the RP address when the RP fails, so that the new RP address corresponds to that of a different router. However, the new RP address has to be communicated to other routers in the network. A further solution includes changing the IP address of a newly designated router to the RP address, but this change is relatively slow.

### BRIEF DESCRIPTION OF THE DRAWINGS

The present invention is illustrated by way of example and not limitation in the figures of the accompanying drawings, in which like references indicate similar elements and in which:

FIG. 1 is a schematic diagram showing the network topology of a PIM system in accordance with the invention.

FIG. 2 is a flow diagram of a method, in accordance with an example embodiment, of providing an RP facility during PIM sparse mode communications over the system of FIG. 1.

FIG. 3 shows a diagrammatic representation of a network device in the example form of a router within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

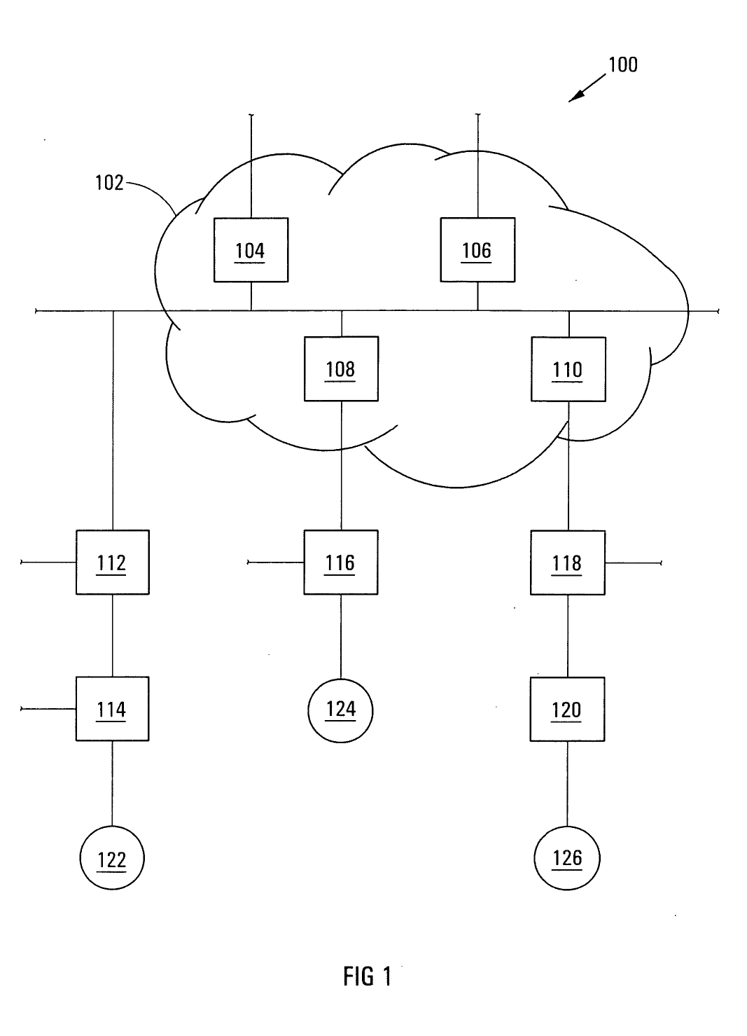

In FIG. 1 of the drawings, a portion of an electronic data communications network is generally indicated by reference numeral 100. In this example, the network 100 forms part of the Internet. A sub-network 102, which includes a plurality of routers 104-110, forms part of the network 100. The network 100 includes further routers 112-120 which are outside the sub-network 102. These routers 112-120 connect a plurality of host computer systems 122-126 to the network 100. Although the example embodiments are illustrated with reference to network devices in the form of routers 112-120, it will be appreciated that methodology described herein may also be deployed in switches or the like.

The network 100 is a multicast network which uses sparse mode PIM. It will be appreciated by a person skilled in the art that sparse mode PIM uses a pull model to send multicast traffic, so that only hosts 122-126 which have explicitly requested to receive multicast traffic will receive it. This can be distinguished from dense mode PIM that uses a push model in which every host 122-126 will be sent multicast traffic until that host explicitly requests not to receive multicast traffic.

In a sparse mode PIM system, information about hosts 122-126 which send multicast data (e.g., multicast sources) is communicated by forwarding data packets on a shared tree. Because sparse mode PIM uses a shared tree (at least initially), the use of a RP, which forms the root of the shared tree, is required. A source, for example host 122, therefore, in use, sends data packets to a designated router 114 on the sub-network of the host 122. The designated router 114 in turn encapsulates and sends data packets to the RP, which forwards the data packets down the shared tree to a multicast group. All routers 112, 114 in a path from the source to the RP set a (S, G) flag which indicates that a source 122 in their path is sending multicast data.

Receivers, for example hosts 124, 126 similarly indicate that they wish to receive multicast data by sending join messages to designated routers, for example routers 116, 120 respectively, on the sub-network of the hosts 124, 126. The designated routers 116, 120 in turn encapsulate and send join messages to the RP. All routers 116-120 in a path from the respective receivers 124, 126 to the RP set a (*, G) flag, which indicates that multicast data is to be sent from the RP along their path. The flag (*, G) is used to create the shared tree.

The shared tree in sparse mode PIM is unidirectional, which means that multicast data is forwarded to the root of the shared tree (e.g., the RP), from which the data is forwarded down the shared tree. In bidirectional PIM, multicast data is forwarded both up and down the shared tree. The shared tree still needs a root and is rooted at the RP, but the RP need not be a router 104-110 and can merely be an IP address reachable on the network 100.

A sparse mode PIM network 100 therefore requires a RP, and it further requires that the RP be associated with a physical router 104-110. In accordance with an embodiment, the RP is provided by one of the routers 104-110 in the sub-network 102. Each router 104-110 in the sub-network 102 has a respective individual primary IP address assigned to it. In conventional format, each IP address comprises, in decimal format, four fields separated by periods. The first three fields of each of the routers' IP addresses are identical, due to the routers' forming part of the same sub-network 102. The final field of the respective primary IP addresses, however, are different. In this example, the IP address of the sub-network 102 may be 10.1.1.0, the IP addresses of the routers 104-110 being 10.1.1.1, 10.1.1.2, 10.1.1.3, and 10.1.1.4 respectively. In this example, the first 24 bits (which represent the first three fields in the dotted syntax given above) of the IP addresses are used to identify the sub-network 102, so that the sub-network 102 in this example is a /24 sub-network. It is to be appreciated, however, that the method and system are applicable to sub-networks having IP configurations ranging from /2 to /30.

An IP address assigned to the RP (further referred to as the RP address) also corresponds to the IP address of the sub-network 102, in that the first three fields are identical, but the RP address is different from the primary IP addresses of the respective routers 104-110. The IP address of the RP is, in this example, 10.1.1.250.

Each router 104-110 within the sub-network 102 has stored thereon a computer program comprising a set of computer readable instructions which are executable to direct the operation of the routers 104-110. The computer readable instructions include designation rules to select one of the routers 104-110 as the DR (Designated Router). In this example, the rule is that the router 104-110 which has the highest IP address and which is operative is selected as the DR. It is to be appreciated, however, that other rules can be selected and that, for example, the IP addresses, the routing speeds, the capacities, and/or the physical locations of the routers 104-110 can be taken into account in selection of the DR.

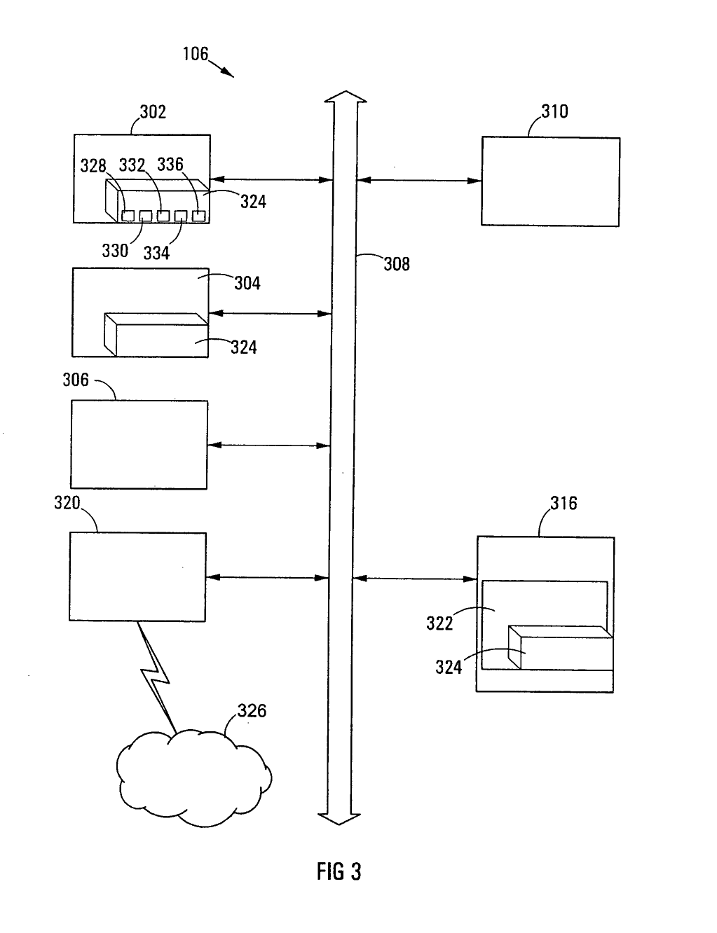

FIG. 3 shows a diagrammatic representation of a networking device or machine in the example form of a router 106 within which a set of instructions, for causing the machine to perform any one or more of the methodologies discussed herein, may be executed. Instead of a network router, the machine may be a switch, bridge, or any machine capable of executing a set of instructions (sequential or otherwise) that specify actions to be taken by that machine. Further, while only a single machine is illustrated, the terms “machine” or “device” shall also be taken to include any collection of machines that individually or jointly execute a set (or multiple sets) of instructions to perform any one or more of the methodologies discussed herein.

The example router 106 includes a processor 302 (e.g., a central processing unit (CPU)), a main memory 304 and a static memory 306, which communicate with each other via a bus 308. The router 106 may further include a display device 310 (e.g., a liquid crystal display (LCD), a cathode ray tube (CRT), or a cluster of light emitting diodes (LEDs)). The router 106 may also include a disk drive unit 316, and a network interface device 320.

The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the router 106, the main memory 304 and the processor 302 also constituting machine-readable media.

The software 324 may further be transmitted or received over a network 326 via the network interface device 320 utilizing any one of a number of well-known transfer protocols (e.g., HTTP).

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The processor 302, when executing the instructions 324, in co-operation with hardware of the router 106, provides, inter alia, an address arrangement 328, an activation component 330, an RP module 332, a monitoring module 334, and a selection component 336.

The address arrangement 328 includes at least an individual IP address assigned specifically to the router 106, and preferably an additional IP address corresponding with the RP address.

The activation component 330 is operable to modify the address arrangement 328 in the event of designation of the router 106 as DR., modification of the address arrangement 328 comprising activation of the additional IP address, so that both the individual IP address of the router 106 and the RP address are active. More specifically, the activation component 330 is operable to deactivate the RP address on each of the other routers on the sub-network 102 by sending an address resolution communication to the other routers.

The RP module 332 is operable to perform RP processing when the RP address has been activated as an additional address, so that the router 106 performs RP processing on the sub-network 102.

The monitoring module 334 is operable intermittently to communicate the status of the router 106 to a plurality of other routers on a shared sub-network and to receive similar status communications from the other routers, to monitor the status of at least a designated router (DR) which performs RP processing on the sub-network 102.

The selection component 336 is operable to select, in co-operation with the other routers on the sub-network 102, one of the routers as new DR in the event of a failure event associated with the DR. The selection component 336 includes designation rules for automatically selecting a new DR upon failure of the DR.

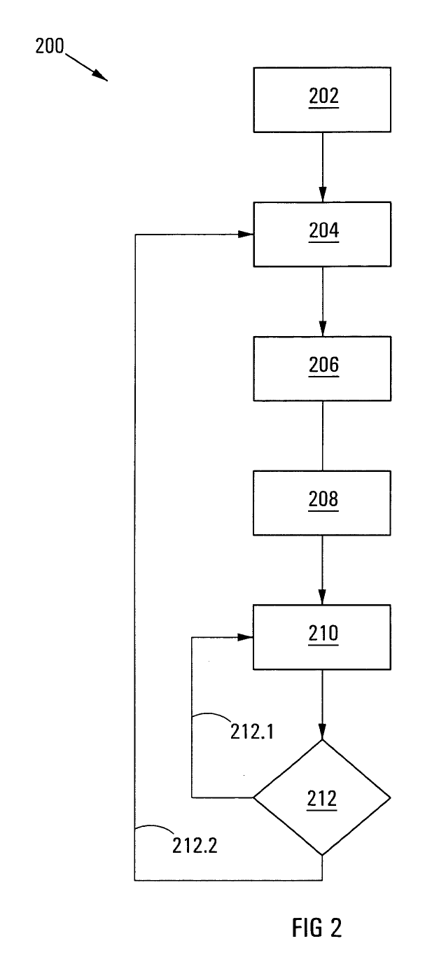

In use, and referring now also to FIG. 2 which shows a flow diagram 200, the process of initially designating a DR is initiated, at block 202. At block 204, based on a designation rule, one of the routers on the sub-network 102 is then designated as the DR. Broadly, embodiments allow a subnet (e.g., the sub-network 102) to negotiate which router (e.g., one of the routers 104-110) will be the DR in accordance with the PIM specification. For example the designation rule may stipulate that the router with the highest IP address should be designated as the DR. In the given example the router 110 is shown to have the highest IP address (10.1.1.4) and, accordingly, the router 110 is therefore initially selected, at block 206, as the DR

When a particular router has been selected as the DR, the selected router (e.g., router 110) then takes over the DR functionality which, in an example embodiment, includes installing a secondary IP address on that subnet interface (see block 208). It will be appreciated that other routers on the network are unaffected by the designation of the DR by the sub-network 102. Once the router has been designated as the DR, the DR 110 has an active secondary IP address which corresponds to the RP address.

Thus, in an example embodiment, the DR 110 now has two IP addresses: a primary IP address and secondary IP address which is the RP address. The sub-network 102 thus provides an RP facility for multicasting in sparse mode PIM, all data packets being sent to the RP address being forwarded to the DR 110 for processing to perform rendezvous point processing in the usual fashion.

At block 210 the designated router is monitored to determine if it operative and functional. As shown at decision block 212, if the designated router remains operative there is no need to designate another router as the DR and the RP functionality continues to be performed by the DR (see branch 212.1).

If, however, the DR (e.g., the router 110) becomes inoperative, one of the other routers 104-108 must be designated as the new DR. In the given example, the router with the next highest IP address is selected as the DR (e.g., router 108 with IP address 10.1.1.3). Accordingly, as shown by branch 212.2, a new DR is identified and selected, at block 206, as the new DR.

In the given example the DR 108 now has two IP addresses: a primary IP address and a secondary IP address which is the RP address. The sub-network 102 thus still has a RP which is reachable at the same RP address which was used previously, even though RP processing is now done by the new DR 108.

The routers 112-120 and hosts 122-126 outside the sub-network 102 continue to communicate in sparse mode PIM with the RP in conventional fashion, and are oblivious to a change in the DR. The RP, regardless of which router 104-110 is acting as the RP, may also communicate with the routers 112-120 and hosts 122-126 outside the sub-network 102 in conventional fashion.

Thus, in an embodiment, RP redundancy may be provided by providing a secondary IP address without a need to change the IP address of the RP. Associating the RP with a new router 104-110 should the DR become inoperative is relatively quick, as no IP addresses need to be changed. In the example embodiments described above, the operative DR with the highest address is selected as the RP. It will be appreciated that the different rules may be used in other embodiments to select the RP. Further, the configuration of the router may be a static configuration, a BSR configuration, or an auto RP configuration.

Unlike a conventional system where the RP corresponds with a physical device and a host may route the RP to different physical locations on a network, in example embodiments of the present application, the RP address is not fixed to a physical device. Rather, the DR that is on the same subnet as the RP address becomes responsible for performing the RP functionality. RP functionality may thus be associated with a “phantom” RIP. In an example embodiment, by replacing an interface field in announce and candidate-RP configuration commands with a specific IP address, auto-RP and BSR can be used to distribute the Phantom RP.

In an embodiment, PIM RP distribution may remain as defined in the RFC 2362 using, for example, BSR, Auto-RP, and Static RPs. The phantom RP may be located as a virtual system on a subnet at the core of the network. This virtual system for Bidirectional PIM does not require any interaction with the rest of the routers in the PIM domain because PIM joins are sent toward this IP address and not to this IP address. Each router along the forwarding path must be able to process these PIM control messages.

The sparse mode PIM RFC requires the RP first to process PIM register packets, and secondly to trigger (S, G) joins toward the source listed in the PIM register if (*, G) state already exists. The PIM RIP may be identified by an IP address. PIM registers are sent to the PIM RP and processed only by the RP. Therefore the phantom RP methodology described herein may require delegation of these functions to a RP that is located on the same sub-network as the virtual router. For example, the IP address of the PIM RP might be 10.1.1.1/24 (the IP address is located on the subnet 10.1.1.0) so some system (router or switch) that is on this subnet (called the RP subnet) must perform the RP function. Each subnet within a PIM domain (networks configured to run PIM may select a DR (designated router) according to the PIM specifications. The DR may be the router which will be designated as the phantom RP (or proxy RP).

In an example embodiment, the phantom RP may install an additional IP address on its interface which is connected to the RP subnet, which means that PIM register messages will be sent to the phantom RP for processing which will occur as specified in the RFC.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method of providing rendezvous point (RP) functionality in protocol independent multicast (PIM) communications in a communications network, the method comprising:
defining an RP sub-network identified by an RP address, the RP sub-network comprising a plurality of network devices; and
designating one of the plurality of network devices to perform RP functionality based on a designation rule.

2. A method as claimed in claim 1, in which the network device is a router or switch.

3. A method as claimed in claim 1, in which the designation rule is that the network device which has the highest IP address is designated.

4. A router for routing data during multicast communications in PIM sparse mode, the router comprising:
an address arrangement which includes at least an individual IP address assigned specifically to the router;
an activation component configured to modify the address arrangement in the event of designation of the router as designated router (DR) for performing RP processing, modification of the address arrangement comprising activation of an additional IP address corresponding with a predefined rendezvous point (RP) address, so that both the individual IP address of the router and the RP address are active; and
an RP module configured to perform RP processing when the RP address has been activated as an additional address.

5. A router as claimed in claim 4, which comprises a monitoring module to communicate with a plurality of other routers on a shared sub-network, to monitor the status of at least a designated router (DR) which performs RP processing on the sub-network, the router further including a selection component to select, in co-operation with the other routers on the sub-network, one of the routers as new DR in the event of a failure event associated with the DR.

6. A router as claimed in claim 5, in which the monitoring module is configured intermittently to communicate its status to the other routers in the sub-network, and to receive similar status communications from the other routers.

7. A router as claimed in claim 5, in which the activation component is configured to deactivate the RP address on each of the other routers on the sub-network by sending an address resolution communication to the other routers.

8. A router as claimed in claim 4, in which the selection component comprises designation rules to automatically select a new DR upon failure of the DR.

9. A method of providing a rendezvous point (RP) facility in sparse mode protocol independent multicast (PIM) communications over a data communication network, the method comprising:
selecting as designated router (DR) a particular router on a sub-network which includes a plurality of routers with respective individual IP addresses, so that the DR performs RP processing during PIM multicasting, an additional active IP address of the DR being a specified RP address to which multicast data is sent for RP processing; and
designating another router on the sub-network as new DR in response to occurrence of a predetermined failure event associated with the DR, designation of the new DR being by activating the RP address on the new DR in addition to the new DR's individual IP address, so that the new DR performs RP processing after its designation.

10. A method as claimed in claim 9, which comprises intermittently sending status communications from the DR to the other routers on the sub-network, and automatically designating another router on the sub-network as new DR in the event that the intermittent status communications from the DR are interrupted.

11. A method as claimed in claim 9, which comprises assigning to each router in the sub-network both its respective individual IP address and an additional IP address which is identical to the RP address, designation of a particular router as the DR comprising deactivating the additional IP address of all the routers in the sub-network other than the DR, so that only the DR has an active additional IP address which corresponds to the RP address.

12. A method as claimed in claim 9, which comprises automatically selecting for designation as new DR one of the routers on the sub-network in response to the occurrence of a failure event associated with the DR, selection of the new DR being based on designation rules.

13. A method of designating a particular router in a data communications sub-network as designated router (DR) for performing rendezvous point (RP) processing during protocol independent multicast (PIM) communication, the method comprising:
assigning to each of a plurality of routers on the sub-network identical IP addresses in addition to each router's individual IP address, the additional IP addresses being identical to an RP address; and
deactivating the additional address of each router except the DR, so that the RP address of only the DR is active.

14. A method as claimed in claim 13, in which deactivating the additional address of each router except the DR comprises the sending of an address resolution communication in respect of the RP address by the DR to the other routers on the sub-network.

15. A machine readable-medium embodying instructions to provide a rendezvous point (RP) facility in sparse mode protocol independent multicast (PIM) communications over a data communication network, the instructions when executed by a machine cause the machine to:
select as designated router (DR) a particular router on a sub-network which comprises a plurality of routers with respective individual IP addresses, so that the DR performs RP processing during PIM multicasting, an additional active IP address of the DR being a specified RP address to which multicast data is sent for RP processing; and
designate another router on the sub-network as new DR in response to occurrence of a predetermined failure event associated with the DR, designation of the new DR being by activating the RP address on the new DR in addition to the new DR's individual IP address, so that the new DR performs RP processing after its designation.

16. A rendezvous point (RP) facility for a sparse mode protocol independent multicast (PIM) system on a data communications network, the R-P facility comprising:
a sub-network which includes a plurality of routers having respective individual IP addresses, one of the routers having an active RP address and thus being a designated router (DR) for performing RP processing;
a selection component to automatically select, in response to a failure event associated with the DR, another router as new DR; and
a designating component configured to designate the selected router as designated router (DR) to perform RP processing, the designating component being configured to activate the RP address on the DR in addition to the DR's individual IP address, so that communications addressed to the RP are routed to the DR.

17. A RP facility as claimed in claim 16, in which each router has both its individual IP address and an additional address identical to the RP address, the designating component being configured to deactivate the additional IP addresses of all the routers in the sub-network other than the DR, to effect activation of the RP address on the DR only.

18. A RP facility as claimed in claim 16, which comprises a monitoring module to monitor the status of the DR, the selection component being configured automatically to select a new DR in response to detection of non-responsiveness of the DR by the monitoring module.

19. A RP facility as claimed in claim 18, in which the monitoring module is operable to effect the intermittent sending of communications at least from the DR to the other routers, the other routers being programmed to initiate selection of a new DR when the intermittent communications from the DR cease.

20. A RP facility as claimed in claim 16, in which each router is provided with a computer program for directing operations of that router, the routers being configured for co-operation, under direction of their respective computer programs, to select a new DR.

21. A RP facility as claimed in claim 16, in which each router on the sub-network is a router to route data during multicast communications in PIM sparse mode, the router comprising:
an address arrangement which includes at least an individual IP address assigned specifically to the router;
an activation component to modify the address arrangement in the event of designation of the router as designated router (DR) for performing RP processing, modification of the address arrangement comprising activation of an additional IP address corresponding to a predefined rendezvous point (RP) address, so that both the individual IP address of the router and the RP address are active; and
an RP module to perform RP processing when the RP address has been activated as an additional address.

22. A network system for use in multicast communications in PIM sparse mode, the network system comprising a rendezvous point (RP) facility for a sparse mode protocol independent multicast (PIM) system on a data communications network, the RP facility comprising:
a sub-network which includes a plurality of routers having respective individual IP addresses, one of the routers having an active RP address and thus being a designated router (DR) for performing RP processing;
a selection component to automatically select, in response to a failure event associated with the DR, another router as new DR; and
a designating component to designate the selected router as designated router (DR) to perform RP processing, the designating component being configured to activate the RP address on the DR in addition to the DR's individual IP address, so that communications addressed to the RP are routed to the DR.

23. A system to provide a rendezvous point (RP) facility in sparse mode protocol independent multicast (PIM) communications over a data communication network, the system comprising:
means for selecting as designated router (DR) a particular router on a sub-network which includes a plurality of routers with respective individual IP addresses, so that the DR performs RP processing during PIM multicasting, an additional active IP address of the DR being a specified RP address to which multicast data is sent for RP processing; and
means for designating another router on the sub-network as new DR in response to occurrence of a predetermined failure event associated with the DR, designation of the new DR being by activating the RP address on the new DR in addition to the new DR's individual IP address, so that the new DR performs RP processing after its designation.
